(19) United States
(12) Patent Application Publication
(10) Pub. No.: US 2013/0036374 A1
(43) Pub. Date: Feb. 7, 2013

(54) METHOD AND APPARATUS FOR PROVIDING A BANNER ON A WEBSITE

(71) Applicant: Ofer MELAMED, New Hyde Park, NY (US)

(72) Inventor: Ofer MELAMED, New Hyde Park, NY (US)

(21) Appl. No.: 13/197,582

(22) Filed: Aug. 3, 2011

(51) Int. Cl. G06F 3/01

(52) U.S. Cl. 715/760

(57) ABSTRACT

Embodiments of the present invention may use a communication network to produce a banner on a website on a client device by requesting and receiving data from website and banner server.

### FIELD OF THE INVENTION

This invention relates generally to the field of internet based communication and more specifically to online banners placed on a website.

### BACKGROUND OF THE INVENTION

In website design and web delivered content, HTML code and Java script are used to enable the design of visual websites with strong user interaction characteristics. Web banners are used in conjunction with websites to advertise third party content or products on the websites, often for the purpose of monetizing the website. Banners are typically placed in prominent locations on the website to draw attention of the website visitor.

### SUMMARY OF EMBODIMENTS OF THE INVENTION

Embodiments of the invention include systems and methods of their use for producing a banner on a client device comprising: sending a first request to a server hosting a website; receiving from the website server content associated with the website and address information of a banner server; sending a second request to the banner server for data associated with a banner corresponding to the website; receiving from the banner server banner data, said banner data including a visual representation of the banner, an image map of the banner, and functional code, wherein said image map comprises a plurality of segments and a respective plurality of functionalities for said segments; producing on a display associated with the client device a representation of the website and the banner by loading into a web browser being executed on the client device content of the website and the visual representation of the banner; and allowing a user of the client device to interact with the banner through the web browser by using a pointing device in connection with the segments of said image map to execute the respective functionalities. According to some embodiments of the invention the banner may be produced using HTML and Java script.

According to some embodiments of the invention the method may record at the banner server frequency and type of client interaction respectively for each of the segments. According to some embodiments of the invention the method may include requesting a form for modifying data associated with the segments from said banner server; receiving from said banner server the form; loading said form with data and specifying the intended segment; sending said form loaded with data to said banner server to update the data stored on said banner server for said pixel.

According to some embodiments of the invention the method may include receiving from the client an interaction with a segment of the image map; requesting from the banner server data corresponding to the specific combination of segment and type of interaction; receiving from the banner server requested data; and executing the received data in the client web browser to cause a further action.

According to some embodiments of the invention said further action may be producing a message form; said message form overlays at least some of said banner; and populating and arranging the message form according to the received data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a method in accordance with embodiments of the present invention;

FIG. 2 is a schematic flow chart diagram of a method in accordance with an embodiment of the present invention;

FIG. 3 is a representation of the visual output of a client web browser in accordance with an embodiment of the present invention; and

FIG. 4 is a representation of the visual output of a client web browser in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention may be used in internet or other communication networks in connection with web servers and a client web browser. Embodiments of the invention may provide a banner on a website, which may be in response to a client request, by executing data which may be received from a website server and a banner server.

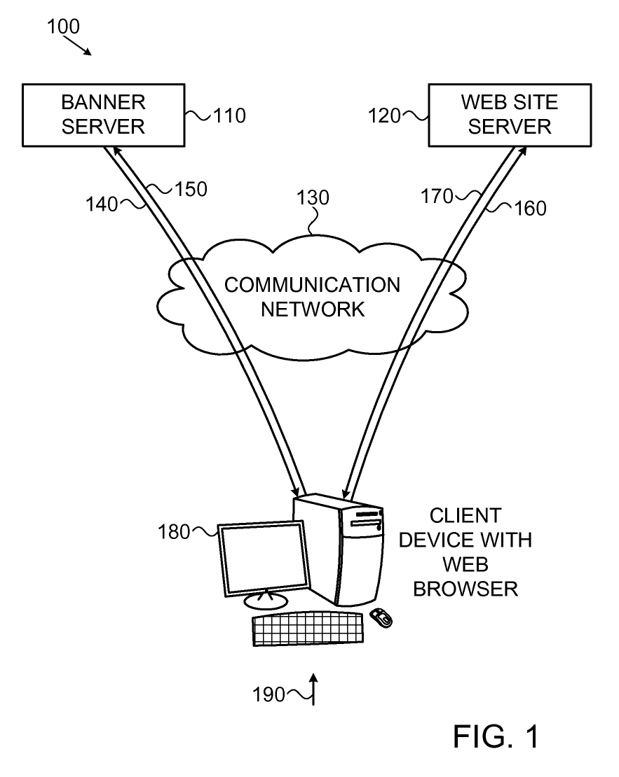

FIG. 1 is a block diagram of a method 100 in accordance with embodiments of the invention. The method may be used to provide a banner on a website. A client may, by using a client device, request a website (190). The client request may be a manual request such as clicking a hyperlink, providing the address of the requested website in a web browser, receiving the website as a result of a web search, for example Google, or the like. The client request may be automatically generated by means including a program running on a client device, a client side code or server side code sending the request as part of executing a process or in response to a client action.

A client device (180) may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise a Random Access Memory (RAM), a Read Only Memory (ROM), a magnetic drive, a disk drive, a Compact Disk (CD) drive, a Digital Video Disk (DVD) drive, a removable media storage, any other suitable data storage medium, or a combination of any of the preceding. A client device may be a wired or mobile communication device. A wired communication device may include a computer terminal, a server or an internet enabled device such as an HDTV which may be capable of communicating over a communication network (130) and executing files in a web browser. A mobile communication device unit may comprise any device operable to communicate over a wireless communication network, for example, a personal digital assistant (PDA), a cellular telephone, a mobile handset, a laptop computer, tablet or any other device suitable for communicating signals over a wireless network.

The client device (180) may send a first request (130) through a communication network (130) to a website server (120) that may be connected to the communication network (130).

A communication network (130) may comprise all or a portion of a public switched telephone network (PSTN), a public or private data network, a local area network (LAN), a metropolitan area network (MAN), a wide area network (WAN), a global computer network such as the Internet, a wireless network, a local, regional, or global communication network, an enterprise intranet, other suitable communication link, or any combination of the preceding.

A website server (120) may refer to any logical device capable of storing data, having a communication interface to a communication network, being able to receive requests for stored data and send replies that may include the requested data over a communication network.

The client device (180) may receive (170) from the web server (120) through the communication network (130) the contents associated with the website that may be necessary to implement the website in a web browser and may receive address information for the banner server (110).

The received contents may include files received over the communication network that may comprise executable and non-executable computer files. Executable files may include files capable of being executed in a web browser and may produce a part or a whole of a representation of a website when executed. The files may be composed in protocols such as HTML, Java Script or another script alternative, PHP, CSS, XML, SWF or the like. The received content may include nonexecutable files that may comprise among other file types, image files such as those stored in JPG, GIF, PNG, BMP, text files or multimedia files.

The address information for the banner server (110) may refer to an address on the communication network which may be associated with the banner server (110) and may be specified in HTTP or FTP link protocol, as an IP address, or other communication network addressing protocol. The address information received (170) from the website server (120) may be part of a nonexecutable file containing the address information or may be part of an executable file from the web site server (120) and the information may be accessible by the client device once the file is executed by the client.

A web browser may be any software application capable of performing some combination of sending a request to a server over a communication network, receiving data from a server over a communication network, executing data and presenting to a client a web site, image, video, or other content.

The client device (180) may then send a request (150) through the communication network (130), using the received banner server address, to the banner server (110) that may be connected to the communication network (130).

A banner server may refer to any logical device associated with storing the banner data that may be capable of storing data, having a communication interface to a communication network (130), being able to receive requests for stored data and send replies that may include the requested data over a communication network (130).

The client device (180) may receive (140) from the banner server (110) through the communication network (140) banner data including a visual representation of the banner, an image map and may receive functional code associated with implementing the banner functions.

The banner data may refer to any or all of the latest versions of the corresponding visual representation of the banner, image map, and functional code that may be stored for retrieval on the banner server (110), or may refer to the latest version that has been approved by the banner host.

The received visual representation may refer to a digital image file store in a format including JPG, PNG, GIF or BMP. The file may contain a representation of a banner, which may be rectangular or of another form. The banner may be of any size or dimension. The banner visual representation may be placed anywhere on the website. The location of the web banner may be dictated by functional code that may be received from the web site server (120). The file might be a representation of a single image or may visually represent a banner divided into a plurality of segments and each segment may encompass a separate image. The banner visual representation may display a grid identifying the boundaries of the segments. Some embodiments may include segments that may be left blank, highlighted, colored or the image encompassed by the area of a segment may be made more or less transparent than the rest of the banner.

The received image map may be any browser readable file which may contain a list of coordinates relating to a specific image. The coordinates may relate to segments of the image and may contain corresponding hyperlinks or computer executable instructions for further actions which may be executed in response to a client interaction with an associated segment. According to some embodiments of the invention a client interaction may be accomplished through the use of a pointing device. According to one embodiment of the invention a pointing device may include a pointing device which translates a clients input to a relative position on the screen or a direct input to a position on the screen such as a touch input on a touch enabled media. A client may be able to interact with each segment individually. In some embodiments of the invention the client interaction may include hovering or click via a mouse or tapping and double tapping on a touch enabled media. The image map may contain multiple hyperlinks or computer executable instructions for each segment which may correspond to multiple client interactions with the segment of the image. The functional code may include computer executable instructions for retrieving additional content from a banner server or executing some other further function.

The client device (180) may then load the data received from the website server (120) and may load the visual representation of the banner, the image map and the functional code in a web browser. The web browser may then execute the files and may produce a website with a banner. The website may display the received visual representation as the banner. If a client interacts with a segment of the banner, the interaction may cause a further action depending on the image map. The further action which may be opening a new address location, displaying an overlay message form or some other action.

According to some embodiments of the invention, the interactions the client may have with the segments of the banner may be recorded. Recording the interactions may include writing to a log file the frequency and/or the type of interaction the client may have with the each segment of the banner. The log may comprise a database. In one embodiment of the invention the database may be a server side database and may be stored on the banner server (110).

According to some embodiments of the invention, some or all of the acquisition, updating, maintenance of the banner pixels or other transactions may take place on the banner server. According to some embodiments of the invention, in response to a client request sent to the banner server a form may be provided for acquisition, updating and maintenance of the banner pixels or other transactions over the communications network to the client device. The form may be produced in response to a client interaction or it may appear as part of the user interface. According to another embodiment of the invention a client may request a form over the communication network from the banner server and receive data from the banner server which when executed in the client web browser may produce a website containing a form, wherein the website may be fully produced with data from the banner server.

According to one embodiment of the invention, the form may include a login function or login indication. A login indication may refer to a login accomplished on a third party service which communicates to the form that a successful login has been achieved. Such third party services may include Facebook connect or the like. According to another embodiment of the invention the form may allow the client to enter data which may be new data associated with a segment of the banner or modifications to current data associated with a segment of the banner. The data entered by the client may then be saved to the banner server. A banner produced subsequent to new data being saved on the banner server associated with the banner, may be produced in part using the newly saved data.

According to some embodiments of the invention, the banner may have a set of tools that may allow the client to search the contents of the banner, or may enlarge the content or may have other additional functions. According to one embodiment of the invention the banner tool set may include a button which may be embedded either within the image map or externally of the image map. The button may instruct the client banner interaction to be modified to another interaction type. According to one embodiment of the invention the client interaction may be changed from a hover over interaction which may produce an overlay message form to a magnifying glass icon which may enlarge an immediate area of the banner image selected by a client.

According to some embodiments of the invention a search function may be included in the banner tool set. A client may, by interacting with a search input, query the banner for a query term or category type. According to one embodiment of the invention, the search function may in response to a client prompting a query of a term or category highlight or display only those segments of the image map which may be associated with the query term or category. The search function may query the database associated with the banner which may be located on the banner server. Based on the results of the database query the client device may receive data which may instruct the client device to regenerate the banner.

According to some embodiments of the invention, a client may be able to modify the content associated with a segment of the banner through the client web browser by accessing a form that may be hosted on the banner server. According to one embodiment of the invention a client may modify the content of a segment of the banner by interacting with a form as disclosed above.

According to embodiments of the invention the banner may be integrated through code in the website serve and the webhost may be able to write code to manipulate the banner image, modify the image map or modify other code which the banner server may send to the client without directly contacting the banner server as may be achieved by using a form as disclosed above. For example a pixel tracking algorithm may be implemented at the website server without requiring any modification to the data on the banner server.

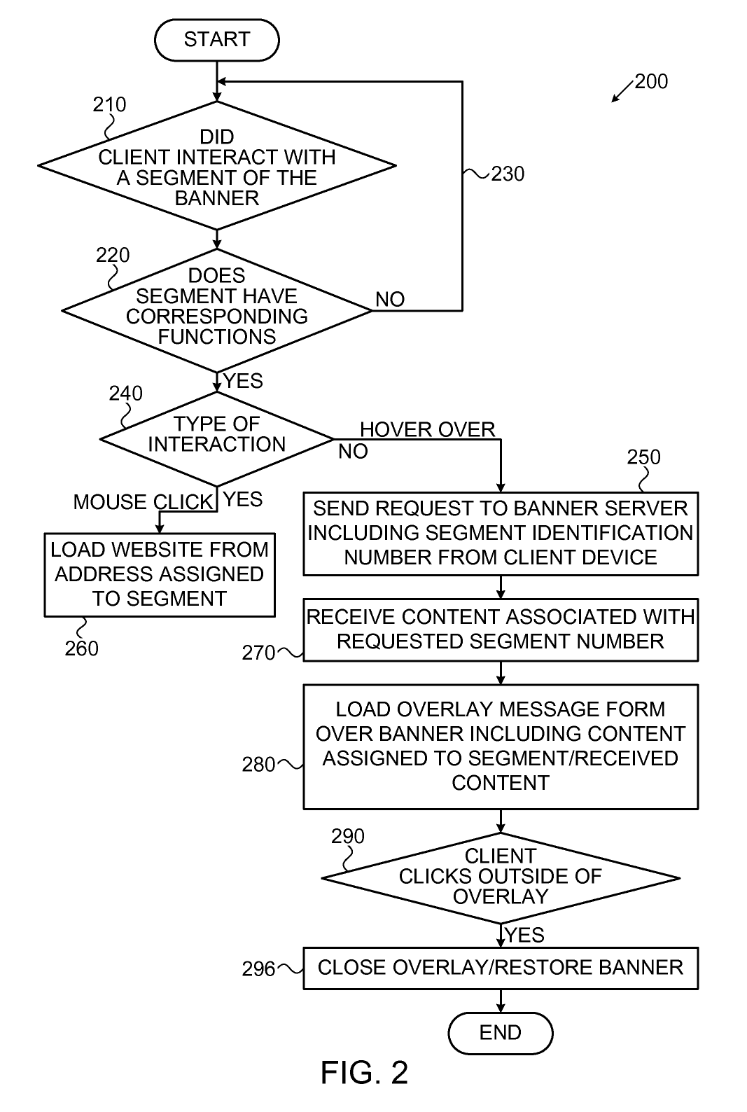

FIG. 2 is a schematic flow chart diagram of method 200, in accordance with an embodiment of the present invention. A trigger function may wait for an interaction by the client with a segment of the banner (210). The segments may be defined by the image map for corresponding to the banner. If an interaction is received and there is no corresponding function assigned to the segment (220) then the method may reset to the trigger function and may await another client interaction (230).

A corresponding action may be a function which may be specified in a banner image map and may correspond to a segment the client may have interacted with and the type of interaction the client may have had with the segment. No corresponding function may refer to a situation when a query of a corresponding banner image map for a segment and type of interaction combination may have produced a null set.

If the segment has a corresponding function, the interaction may be categorized based on the type of interaction (240). A mouse click interaction may prompt the client web browser to load a second website from an address corresponding to the segment the client may have interacted with. The address information may be contained in the image map entry corresponding to the combination of a mouse click and the segment the client may have interacted with. The web browser may load the second web site located at the specified address in the same window as the first website or may open the second website in a new window while the original window may continue to display the first website and banner. A mouse hover-over of a segment by the client may prompt the client device to send a request to the banner server (270). A hover over may occur when a client may place their mouse over a particular segment for greater then a specified period of time. The request may include an identification number that may correspond to the segment the user hovered over. The identification number may refer to a number or term that may be contained in the banner image map entry corresponding to a hover over of a segment and may be associated by the banner server to specific content that may be stored on the banner server. According to one embodiment of the invention a two dimensional coordinate system corresponding to the image map may be implemented to identify the individual segments of the banner. According to another embodiment of the invention a single number assigned to identify each segment of the banner may be implemented.

The client device may then receive the content from the banner server which may correspond to the segment identification number sent to the banner server. The content may include image files such as JPG, GIF, PNG, GIF, text files, HTML and PHP code.

The client web browser may then create a representation of an overlay message form which may be placed over the banner (290). The overlay message may consist of a form possibly of a rectangular shape, which may visually appear to cover the content of the website where it is located. The overlay may include the content assigned to the segment that may have been received from the banner server with the visual representation, image map and functional code, and may include the received content associated with the identification number request. The overlay may appear on top of the banner, on top of the rest of the website or both, and may contain text, images, multimedia, hyperlinks and/or other content. The overlay may be preset to a size or may be automatically adjusted to the size of the content. The position of the overlay may be the same for all overlays or may be assigned for each overlay associated to a segment based on the corresponding data that may be contained in the functional code or image map.

If the client clicks on an area of the website that may include the area outside of the message overlay form (293), the message overlay form, or an area or link that may be associated with the closing function, this may prompt the overlay to close so that the overlay may no longer be visible and may prompt the banner and/or the website to be restored so that all of the content that was overlaid is again displayed. According to one embodiment of the invention, the message overlay form may close automatically in response to another or after a set plurality of overlay message forms have been additionally opened by the client.

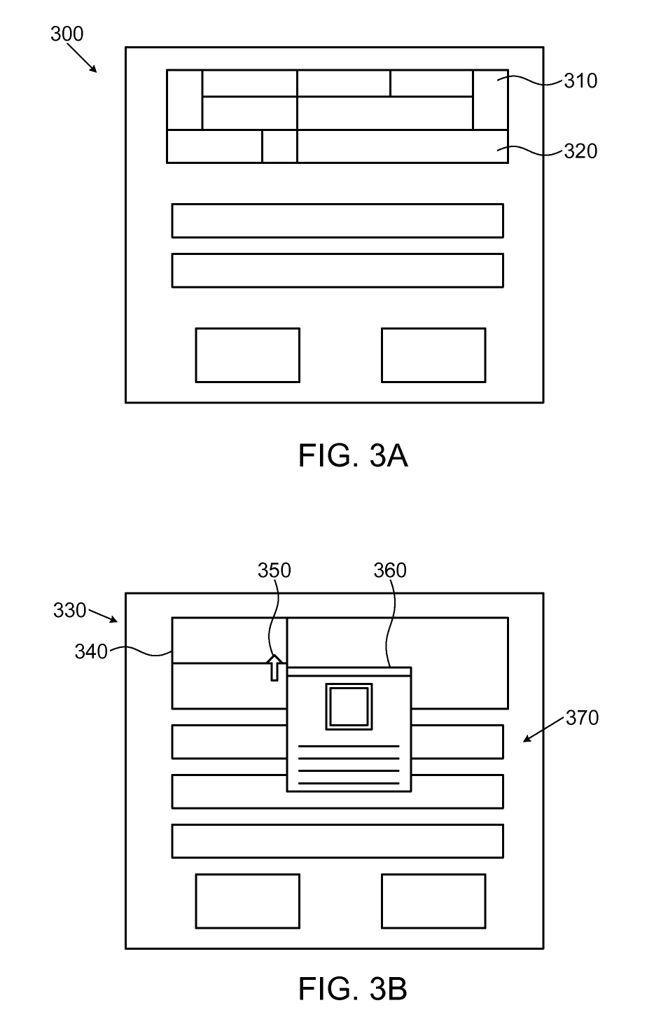

FIG. 3 is a representation of the visual output of a client web browser, in accordance with an embodiment of the present invention. FIG. 3A may represent a website and a banner as it may appear as a visual representation output of a client browser on a client device (300). The banner may be located within a website (310). The banner may be made up of a plurality of segments (320) that may be represented on an image map and may have corresponding functions. The segment boundaries may be visible and the banner may be a visual representation of a plurality of segments that may appear to have individual images contained within. FIG. 3B may represent a website and a banner as it may appear as a visual representation output of a client browser on a client device after a client interaction with one of the segments may have occurred (330). A mouse hover-over (350) over a segment (340) may prompt the web browser to display an overlay message form which appears at a location over the banner (360). The overlay message form may cover up a portion of the banner area and may cover up a portion of the website area outside the banner area. The overlay message form may be a visual representation composed of content associated with the segment the client may have interacted with. It may include content corresponding to the segment that may have been received with the banner visual representation, image map and functional code and may include content received from the banner server that may correspond to the segment of the banner the client interacted with and the type of interaction the client may have had with the segment. A client may click the area outside of the overlay message form (370) and it may cause a client browser to no longer display the overlay message form and may restore the visual representation of the website (300) and banner (310).

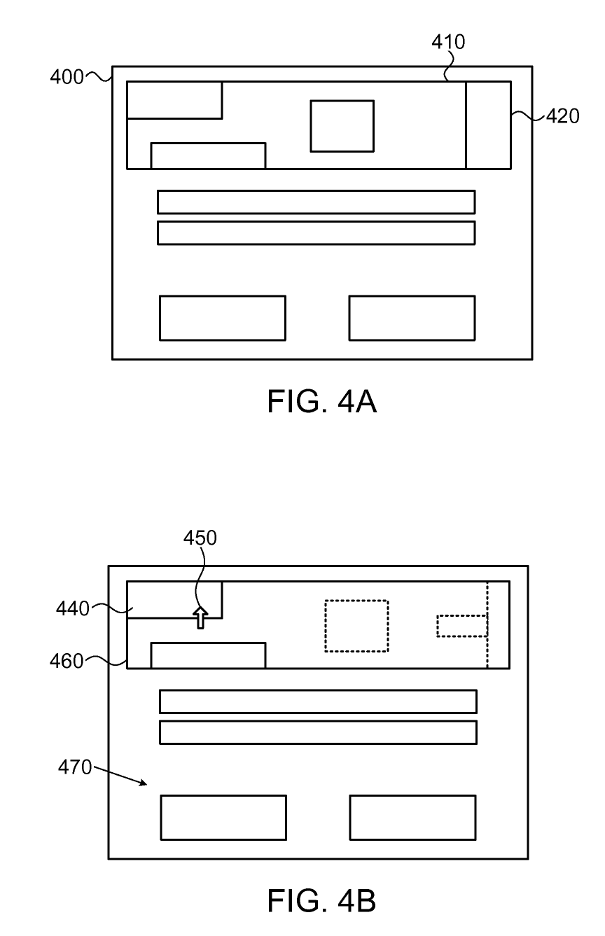

FIG. 4 is a representation of the visual output of a client web browser, in accordance with an embodiment of the present invention. FIG. 4A may represent a website and a banner as it may appear as a visual representation output of a client browser on a client device (400). The banner may be located within a website (410). The banner may be made up of a plurality of segments (420) that may be represented on an image map and may have corresponding functions. The segment boundaries may be invisible and the banner may be a visual representation of a single image. FIG. 4B may represent a website and a banner as it may appear as a visual representation output of a client browser on the client device after a client interaction with one of the segments may have occurred (430). A mouse hover-over (450) over a segment (440) may prompt the web browser to display an overlay message form which may appear over the entire banner area (460). The overlay message form may be a visual representation composed of content associated with the segment the client may have interacted with. It may include content corresponding to the segment that may have been received with the banner visual representation, image map and functional code and may include content received from the banner server that may correspond to the segment of the banner the client interacted with and the type of interaction the client may have had with the segment. A client may click the area outside of the overlay message form (470) and it may cause a client browser to no longer display the overlay message form and may restore the visual representation of the website (400) and banner (410).

According to embodiments of the invention a small block of code may be required to implement the banner on a website. Embodiments of the invention may require less server memory to be dedicated on the website server. Embodiments of the invention may store a large portion, measured in data size, of the content on the banner server and may load the data directly to the client device. Such embodiments may require less synchronization overhead for embodiments which may implement one banner on multiple sites. Some embodiments of the invention may be implemented to display multiple ads at once and may increase the monetizing potential of a single banner.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of producing a banner on a client device comprising:
sending a first request to a server hosting a website;
receiving from the website server content associated with the website and address information of a banner server;
sending a second request to the banner server for data associated with a banner corresponding to the website;
receiving from the banner server banner data, said banner data including a visual representation of the banner, an image map of the banner, and functional code, wherein said image map comprises a plurality of segments and a respective plurality of functionalities for said segments;
producing on a display associated with the client device a representation of the website and the banner by loading into a web browser being executed on the client device content of the website and the visual representation of the banner; and
allowing a user of the client device to interact with the banner through the web browser by using a pointing device in connection with the segments of said image map to execute the respective functionalities.

2. The method of claim 1, wherein the banner is produced using HTML and Java script.

3. The method of claim 1, further comprising recording at the banner server frequency and type of client interaction respectively for each of the segments.

4. The method of claim 1, further comprising:
requesting a form for modifying data associated with the segments from said banner server;
receiving from said banner server the form;
loading said form with data and specifying the intended segment; and
sending said form loaded with data to said banner server to update the data stored on said banner server for said pixel.

5. The method of claim 1, further comprising:
receiving from the client an interaction with a segment of the image map;
requesting from the banner server data corresponding to the specific combination of segment and type of interaction;
receiving from the banner server requested data; and
executing the received data in the client web browser to cause a further action.

6. The method of claim 5, wherein said further action comprises:
producing a message form, wherein said message form overlays at least some of said banner; and
populating and arranging the message form according to the received data.

7. The method of claim 5, wherein said further action comprises:
producing a message form, wherein said message form overlays the entire area of said banner; and
populating and arranging said message form according to the received data.

8. The method of claim 5, wherein different types of client interaction with a segment trigger respectively different further actions.

9. A system for producing a banner on a website, comprising:
at least one server hosting said website accessible via a communication network by at least one client web browser, wherein said website server hosts a web browser executable file containing instructions that when executed by a client web browser cause the browser to:
send a first request to a server hosting a website;
receive from the website server content associated with the website and address information of a banner server;
send a second request to the banner server for data associated with a banner corresponding to the website;
receive from the banner server banner data, said banner data including a visual representation of the banner, an image map of the banner and functional code, wherein said image map comprises of a plurality of segments and a respective plurality of functionalities;
produce a representation of the website with the banner by loading into a web browser on the client device content of the website and the visual representation of the banner, the image map and the functional code; and
allow a user of the client device to interact with the banner through the web browser by using a pointing device in connection with the segments of said image map to execute the respective functionalities.

10. The system of claim 9, wherein the executable file includes HTML and Java script.

11. The system of claim 9, further comprising the banner server, wherein said banner server is configured to record frequency and type of client interaction respectively for each of the segments.

12. The system of claim 9, wherein the executable file containing further instructions that when executed by the client web browser cause the browser upon receiving an interaction from the client with one of the segments of the image map to:
request from the banner server data corresponding to the specific combination of segment and type of interaction;
receive from the banner server requested data; and
execute the received data in the client web browser to cause a further action.

13. The system of claim 12, wherein the further action comprises causing to be displayed a message form, wherein said message form overlays at least a portion of the banner, and wherein the message form is populated and arranged according to the received data.

14. The system of claim 12, wherein said further action comprises causing to be displayed a message form, wherein said message form overlays substantially the entire area of the banner, and wherein the message form is populated and arranged according to received data.

15. The system of claim 9, wherein different types of client interaction with a segment trigger respectively different further actions.

16. A method implemented in a computer-readable medium for producing a banner on a client device comprising:
sending a first request to a server hosting a website;
receiving from the website server content associated with the website and address information of a banner server;
sending a second request to the banner server for data associated with a banner corresponding to the website;
receiving from the banner server banner data, said banner data including a visual representation of the banner, an image map of the banner and functional code, wherein said image map comprising plurality of segments and a respective plurality of functionalities; and
producing a representation of the website with the banner by loading into a web browser on the client device content of the website and visual representation of the banner, the image map of the banner and the functional code, wherein a client can interact through the web browser with the individual segments of said image map and execute the respective functionalities.

17. The method of claim 16, wherein said banner is produced using HTML and Java script.

18. The method of claim 16, further comprising recording frequency and type of client interaction respectively for each of the segments.

19. The method of claim 16, further comprising:
requesting a form for modifying data associated with the segments from said banner server;
receiving from said banner server the form;
loading said form with data and specifying the intended segment; and
sending said form loaded with data to said banner server to update the data stored on said banner server for said pixel.

20. The method of claim 16, further comprising:
receiving from the client an interaction with a segment of the image map;
requesting from the banner server data corresponding to the specific combination of segment and type of interaction;
receiving from the banner server requested data; and
executing the received data in the client web browser to cause a further action.

21. The method of claim 20, wherein said further action comprises:
producing a message form, said message form overlaying at least some of said banner; and
populating and arranging the message form according to the received data.

22. The method of claim 20, wherein said further action comprises:
producing a message form, wherein said message form overlays the entire area of said banner; and
populating and arranging said message form according to the received data.

23. The method of claim 20, wherein different types of client interaction with a segment trigger respectively different further actions.
